(19) United States
(12) Patent Application Publication
(10) Pub. No.: US 2020/0291905 A1
(43) Pub. Date: Sep. 17, 2020

(54) EXHAUST SYSTEM WITH EXHAUST GAS HEAT RECOVERY ASSEMBLY AND METHOD FOR OPERATION OF THE EXHAUST SYSTEM

(71) Applicant: Ford Global Technologies, LLC, Dearborn, MI (US)

(72) Inventor: Sam Revach, Ypsilanti, MI (US)

(21) Appl. No.: 16/298,847

(22) Filed: Mar. 11, 2019

(51) Int. Cl. F02M 26/26; F02M 26/39; F02M 26/70; F02M 26/61; F02M 26/28; F02M 26/30; F02M 26/32

(52) U.S. Cl. CPC F02M 26/26; F02M 26/39; F02M 26/70; F02M 2026/003; F02M 26/28; F02M 26/30; F02M 26/32; F02M 26/61

(57) ABSTRACT

An exhaust system with a first and a second exhaust conduit arranged in a parallel flow arrangement. The exhaust system further includes an exhaust gas heat recovery (EGHR) heat exchanger coupled to an exterior of the first exhaust conduit. The exhaust system further includes a first flow control valve controlling the flow of exhaust gas into the EGHR heat exchanger from the first exhaust conduit and a second flow control valve controlling the flow of exhaust gas through the second exhaust conduit.

### FIELD

The present description relates generally to an exhaust system with exhaust gas heat recovery capabilities and a method for operating an exhaust system.

### BACKGROUND/SUMMARY

Engine exhaust systems have been designed with exhaust gas heat recovery (EGHR) heat exchangers to capture thermal energy from exhaust gases. In certain exhaust systems, EGHR heat exchangers are operated during cold starts to decrease emissions and increase engine efficiency and are shut down after the engine is warmed up.

One example approach is shown by Speer, in U.S. Pat. No. 7,353,865. Speer's system uses an exhaust conduit branching off a primary conduit with an EGHR heat exchanger positioned therein and valving designed to vary gas flow through the branch conduit with the heat exchanger or the primary exhaust conduit. However, when the EGHR heat exchanger is not in operation, unwanted heat may be transferred to the heat exchanger. For instance, the heat transferred to the heat exchanger may come from heat recirculating into the heat exchanger from either the entry or exit ports as well as heat conducted through housing and other structures connecting the heat exchanger to the exhaust system. The engine cooling system therefore experiences unwanted thermal loading when the EGHR heat exchanger is not in operation, thereby decreasing cooling system efficiency. As such, Speer's system may be forced to balance tradeoffs between the heat exchanger's efficiency while the device is active and parasitic losses while the device is shut down. Towing and other high load conditions exacerbate the thermal loading on the cooling system when the heat exchanger is not in operation and may, in some cases, lead to elevated engine temperatures, increasing the chance of thermal damage to engine components, reducing combustion efficiency, and increasing emissions.

In one example, the issues described above may be at least partially addressed by an exhaust system for an internal combustion engine including a first exhaust conduit receiving exhaust gas from a cylinder during internal combustion engine operation and an EGHR heat exchanger coupled to an exterior surface of the first exhaust conduit and including an inlet and an outlet extending through a housing of the first exhaust conduit. The exhaust system further includes a second exhaust conduit arranged in a parallel flow arrangement with the first exhaust conduit and including a conduit body spaced away from the first exhaust conduit, a first flow control valve designed to adjust exhaust gas flow through the EGHR heat exchanger, and a second flow control valve coupled to the second exhaust conduit and designed to adjust exhaust gas flow through the second exhaust conduit. In this way, the benefits of an EGHR heat exchanger can be achieved while reducing the amount of heat transferred to the heat exchanger during periods of heat exchanger inactivity. For instance, while the EGHR heat exchanger is active, the engine's coolant may be warmed up more rapidly, increasing engine efficiency, reducing emissions, and providing a larger thermal reservoir from which cabin heat can be drawn from. In this way, the tradeoffs between EGHR heat exchanger efficiency and parasitic losses caused by thermal loading of the cooling system during EGHR heat exchanger shutdown may be diminished. As a result, engine efficiency is increased, emissions are reduced, and cabin heating can be increased during cold starts without increasing thermal loads on the cooling system when the heat exchanger is shut down, for instance.

In one example, the exhaust system may further include a controller with computer readable instructions stored on non-transitory memory that when executed cause the controller to operate the exhaust system in a first mode where exhaust gas flow through the EGHR heat exchanger is permitted and exhaust gas flow through the second exhaust conduit is inhibited. The controller may further include instructions stored on the non-transitory memory that when executed cause the controller to operate the exhaust system in a second mode where exhaust gas flow through the EGHR heat exchanger is inhibited and exhaust gas flow through the second exhaust conduit is permitted. In this way, the exhaust system may selectively flow exhaust gas through the first or second conduit based on engine operating conditions. For instance, the second mode may be implemented during higher speed and/or higher load conditions and the first mode may be implemented during lower speed and/or lower load conditions. Consequently, heat transfer from the first exhaust conduit to the heat exchanger may be reduced, during high flow conditions for example, while EGHR heat exchanger heat recovery benefits can be achieved during lower load operation, such as cold start operation.

In another example, the exhaust system may further include an insulated union at the inlet of the EGHR heat exchanger. The insulated union may further reduce the amount of heat transferred from the housing of the first exhaust conduit to the EGHR heat exchanger. As a result, the thermal loading on the cooling system during periods of heat exchanger shutdown is further decreased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic depiction of an engine including an exhaust system.

FIG. 2 shows a schematic depiction of a hybrid vehicle.

FIG. 3 shows an example of an exhaust system with an exhaust gas heat recovery (EGHR) heat exchanger.

FIGS. 4-5 show the exhaust system, depicted in FIG. 3, in different operating modes.

FIGS. 6-7 show different detailed views of a flow control valve in the exhaust system, illustrated in FIG. 3.

FIGS. 8-9 show detailed views of another example of a flow control valve that may be included in the exhaust system, shown in FIG. 3.

FIGS. 10-11 show detailed views of an example of a flow control valve that may be included in the exhaust system, shown in FIG. 3.

FIGS. 12-13 show another example of a flow control valve that may be included in the exhaust system, shown in FIG. 3.

FIG. 14 shows an example of an EGHR assembly with insulated unions.

FIG. 15 shows another example of an EGHR assembly with insulated unions.

FIG. 16 shows a cross-section view of one of the insulated unions, shown in FIG. 15.

FIG. 17 shows a method for operation of an exhaust system.

FIG. 18 shows a more detailed method for operation of an exhaust system.

FIG. 19 shows a timing diagram for an exhaust system control scheme.

### DETAILED DESCRIPTION

The following description relates to an engine exhaust system leveraging benefits of an exhaust gas heat recovery (EGHR) heat exchanger (e.g., increased engine efficiency, reduced engine emissions, and increased cabin heating, if desired) during selected operating conditions, such as cold starts. Additionally, the exhaust system also reduces energy transfer from the exhaust gas to the EGHR heat exchanger while the heat exchanger is shut down. Reducing the flow of heat between the exhaust system and the EGHR heat exchanger reduces parasitic losses in the engine during periods when the heat exchanger is disabled. Consequently, the impacts of tradeoffs between the heat exchanger's efficiency when active and parasitic losses while the heat exchanger is disabled may be drastically reduced or avoided, in certain cases.

The exhaust system includes a first exhaust conduit with an exterior surface having the EGHR heat exchanger attached thereto. The heat exchanger receives exhaust gas from an inlet and expels exhaust gas through an outlet. The inlet and outlet of the heat exchanger each extend through an exhaust conduit housing. A heat exchanger flow control valve is coupled to the first exhaust conduit and regulates the flow of exhaust gas through the heat exchanger. For example, to accomplish the heat exchanger flow regulation, the flow control valve may be positioned between the inlet and outlet of the heat exchanger. The exhaust system further includes a branch conduit arranged in a parallel flow arrangement with the first conduit. A branch flow control valve coupled to the branch conduit (e.g., positioned at the upstream confluence of the branch conduit and the first conduit) regulates exhaust gas flow through the branch conduit. The branch flow control valve, for example, may block flow through the first conduit and permit flow through the branch conduit, during, for example, higher speed and/or load conditions. Conversely, in some examples, during lower speed and/or load conditions the branch flow control valve inhibits gas flow through the branch conduit and permits gas flow through the first conduit. It will be appreciated that the heat exchanger may be activated or deactivated while gas flows through the first conduit.

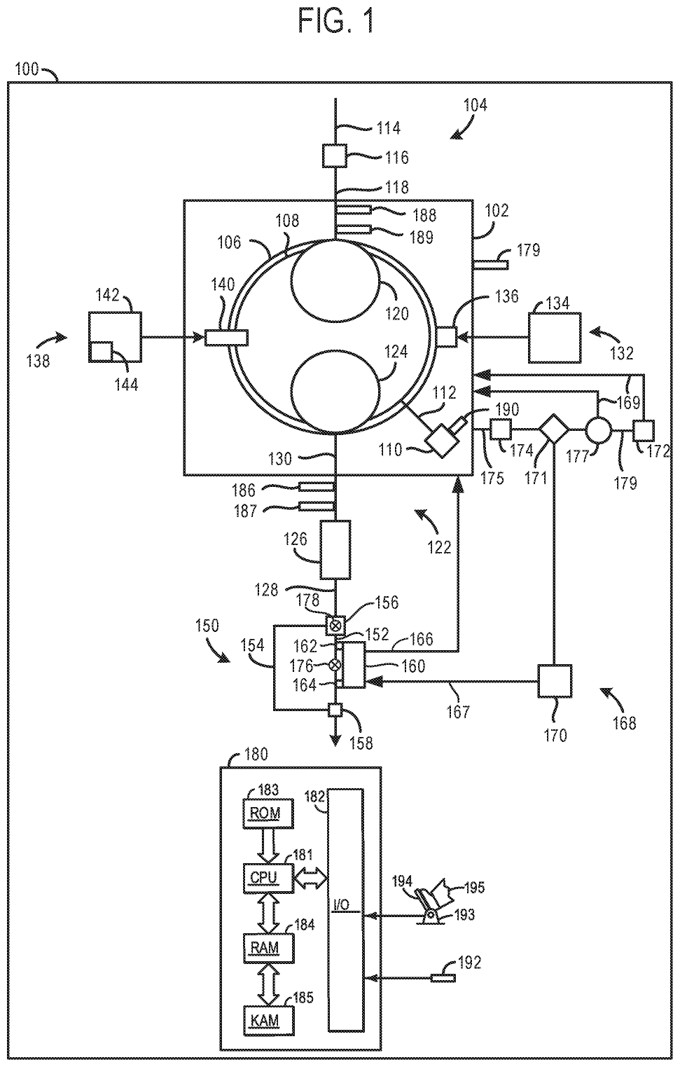

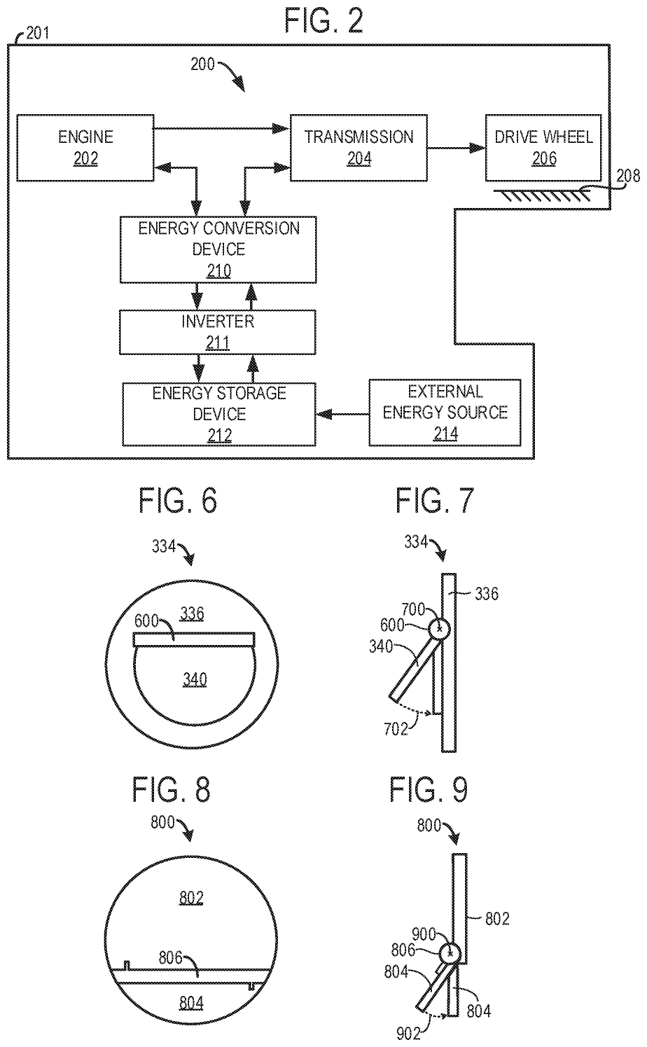

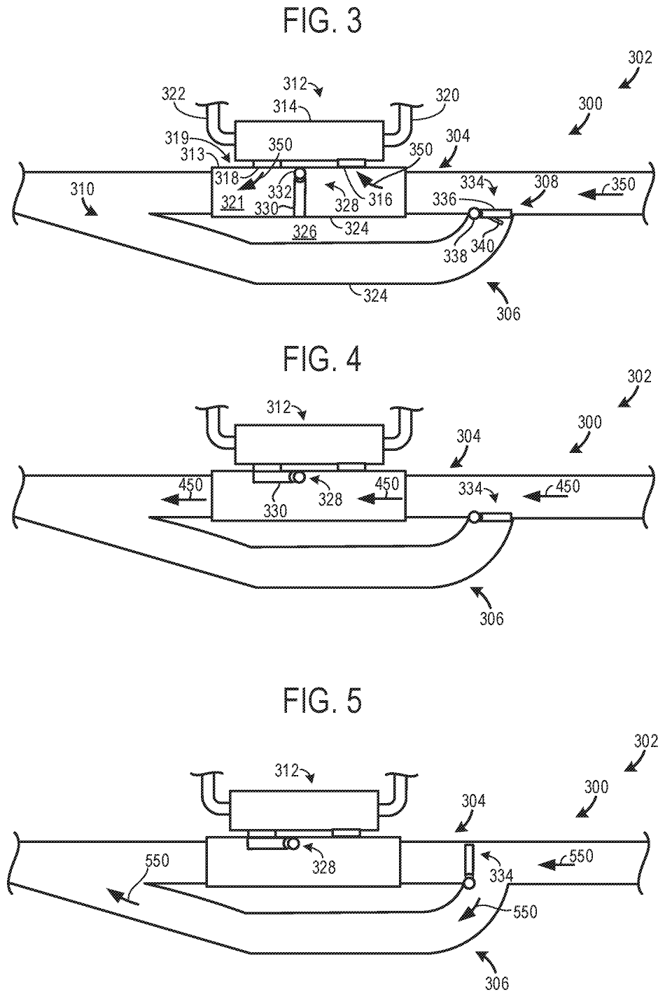

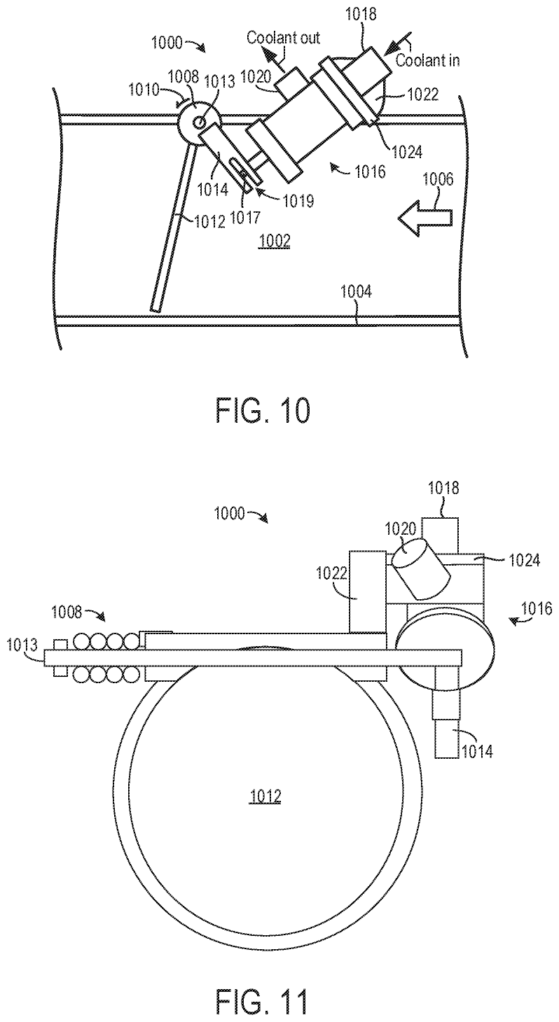

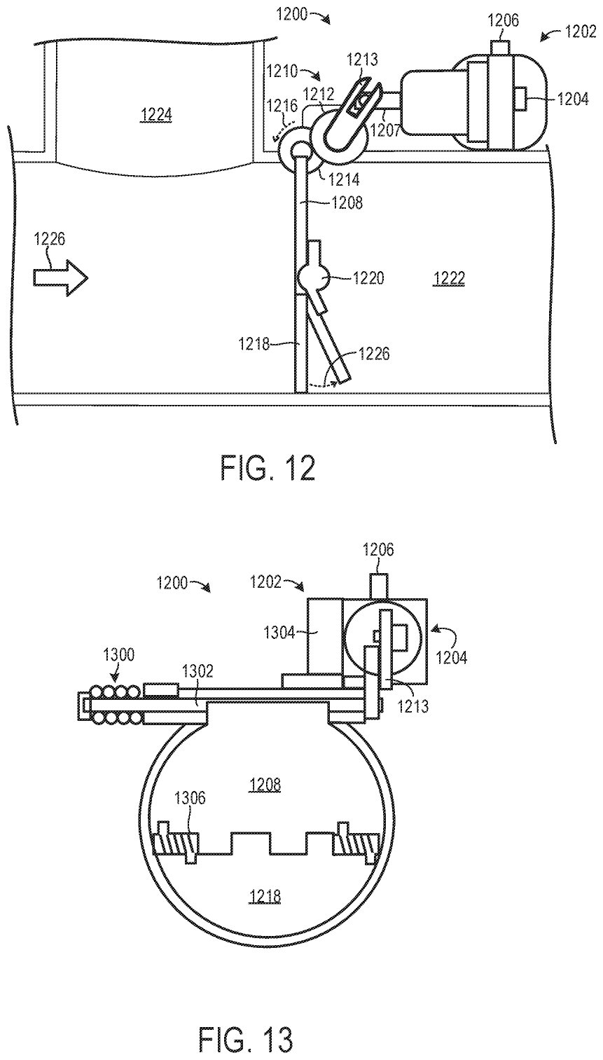

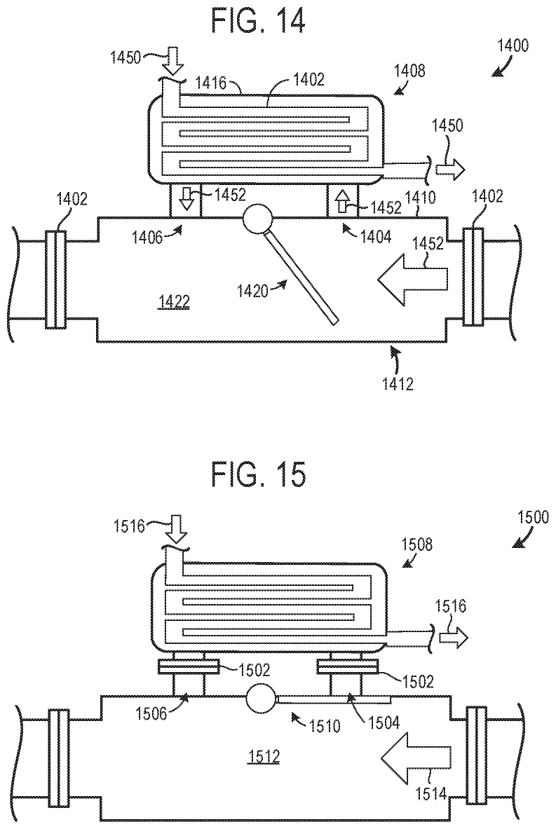

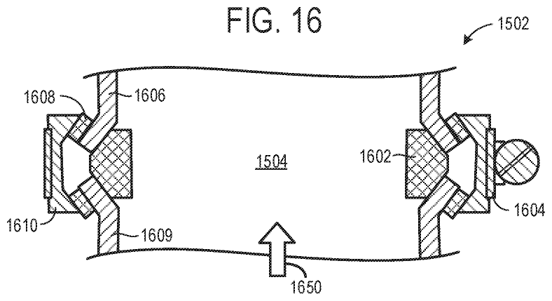

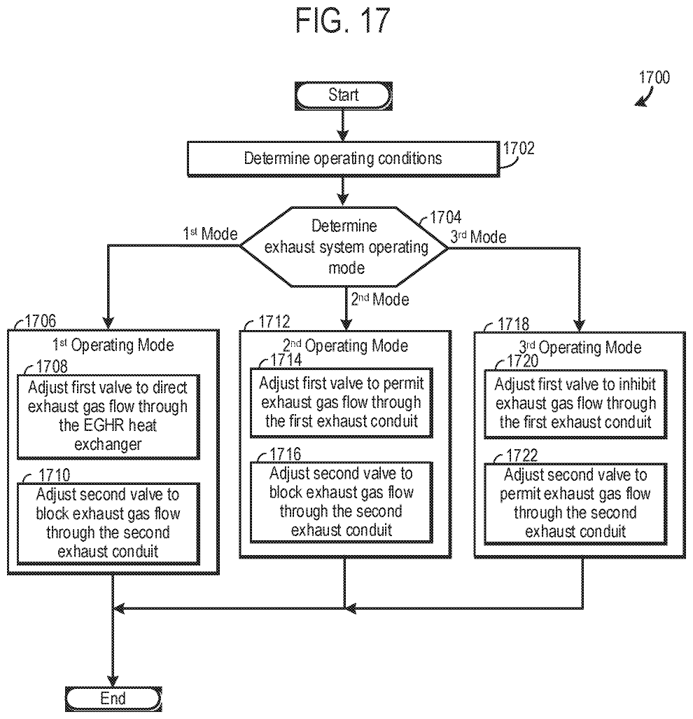

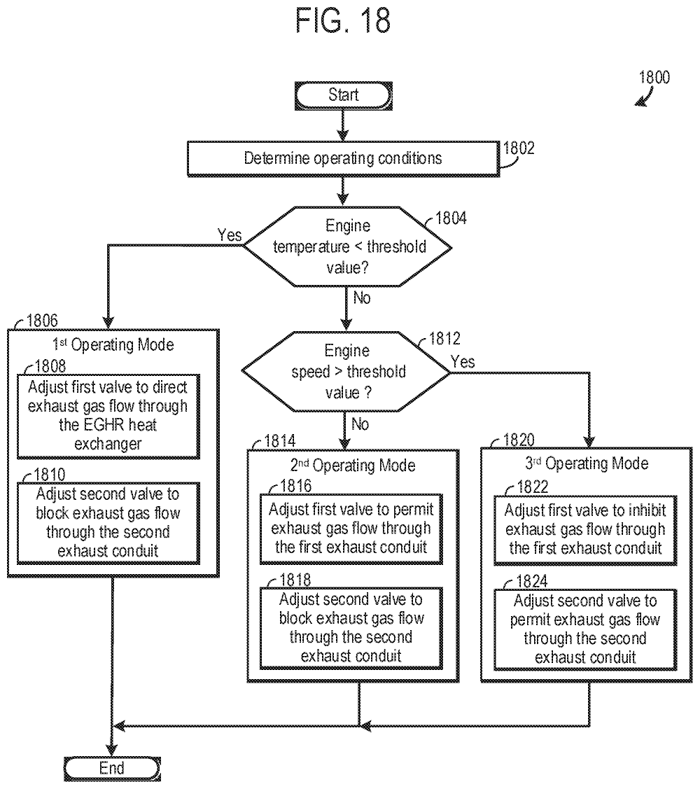

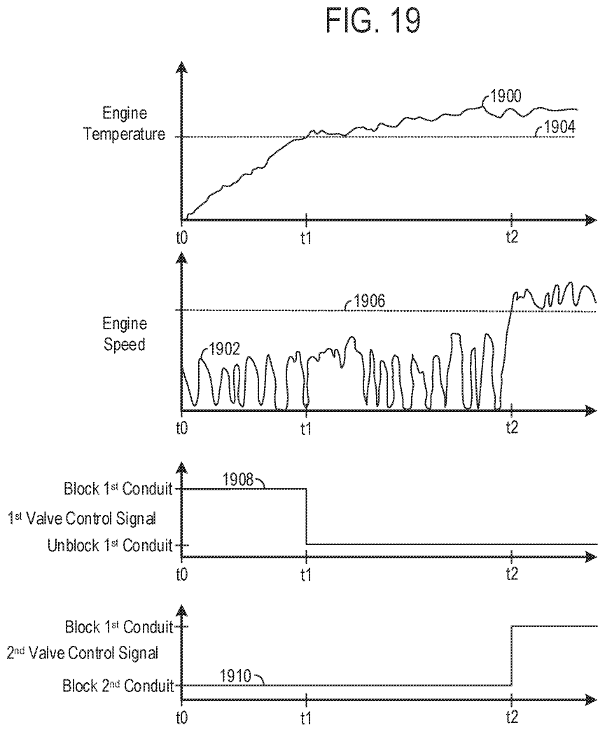

FIG. 1 shows a schematic depiction of an engine with an exhaust system having an EGHR assembly. FIG. 2 shows a schematic depiction of a hybrid vehicle. FIG. 3 shows an example of an exhaust system with an EGHR heat exchanger in a first operating mode where the EGHR heat exchanger is active. FIG. 4 shows the exhaust system, depicted in FIG. 3, in a second operating mode where the EGHR heat exchanger is deactivated. FIG. 5 shows the exhaust system, depicted in FIG. 3, in a third operating mode where the EGHR heat exchanger is deactivated and exhaust is routed further away from the heat exchanger. FIGS. 6-7 illustrate different views of a flow control valve included in the exhaust system shown in FIG. 3. FIGS. 8-9 show different views of another example of a flow control valve that may be included in the exhaust system, shown in FIG. 3. FIGS. 10-11 show different views of yet another example of a flow control valve that may be included in the exhaust system, shown in FIG. 3. FIGS. 12-13 show different views of another example of a flow control valve that may be included in the exhaust system, shown in FIG. 3. FIG. 14 shows a detailed illustration of an example of an EGHR heat exchanger with insulated unions. FIG. 15 shows yet another example of an EGHR heat exchanger with insulated unions. FIG. 16 shows a cross-sectional view of the EGHR heat exchanger, depicted in FIG. 15. FIG. 17 shows a method for operation of an exhaust gas system to augment the amount of heat transferred to an EGHR heat exchanger based on engine operating conditions. FIG. 18 shows a more detailed method for operation of an exhaust system with an EGHR assembly. FIG. 19 shows a graphical representation of an exemplary exhaust system control routine.

FIG. 1 shows a schematic representation of a vehicle 100 including an internal combustion engine 102. Although, FIG. 1 provides a schematic depiction of various engine and engine system components, it will be appreciated that at least some of the components may have different spatial positions and greater structural complexity than the components shown in FIG. 1.

An intake system 104 providing intake air to a cylinder 106, is also depicted in FIG. 1. It will be appreciated that the cylinder may be referred to as a combustion chamber. A piston 108 is positioned in the cylinder 106. The piston 108 is coupled to a crankshaft 110 via a piston rod 112 and/or other suitable mechanical component. It will be appreciated that the crankshaft 110 may be coupled to a transmission that provides motive power to a drive wheel. Although, FIG. 1 depicts the engine 102 with one cylinder. The engine 102 may have additional cylinders, in other examples. For instance, the engine 102 may include a plurality of cylinders that may be positioned in banks.

The intake system 104 includes an intake conduit 114 and a throttle 116 coupled to the intake conduit. The throttle 116 is configured to regulate the amount of airflow provided to the cylinder 106. For instance, the throttle 116 may include a rotatable plate varying the flowrate of intake air passing there through. In the depicted example, the throttle 116 feeds air to an intake conduit 118 (e.g., intake manifold). In turn, the intake conduit 118 directs air to an intake valve 120. The intake valve 120 opens and closes to allow intake airflow into the cylinder 106 at desired times. The intake valve 120, may include, in one example, a poppet valve with a stem and a valve head seating and sealing on a cylinder port in a closed position.

Further, in other examples, such as in a multi-cylinder engine additional intake runners may branch off the intake conduit 118 and feed intake air to other intake valves. It will be appreciated that the intake conduit 118 and the intake valve 120 are included in the intake system 104. Moreover, the engine 102, shown in FIG. 1, includes one intake valve and one exhaust valve. However, in other examples, the cylinder 106 may include two or more intake and/or exhaust valves.

An exhaust system 122 configured to manage exhaust gas from the cylinder 106 is also included in the vehicle 100, depicted in FIG. 1. The exhaust system 122 includes an exhaust valve 124 designed to open and close to allow and inhibit exhaust gas flow to downstream components from the cylinder. For instance, the exhaust valve may include a poppet valve with a stem and a valve head seating and sealing on a cylinder port in a closed position.

The exhaust system 122 also includes an emission control device 126 coupled to an exhaust conduit 128 downstream of another exhaust conduit 130 (e.g., exhaust manifold). The emission control device 126 may include filters, catalysts, absorbers, combinations thereof, etc., for reducing tailpipe emissions. The engine 102 also includes an ignition system 132 including an energy storage device 134 designed to provide energy to an ignition device 136 (e.g., spark plug). For instance, the energy storage device 134 may include a battery, capacitor, flywheel, etc. Additionally or alternatively, the engine 102 may perform compression ignition.

The exhaust system 122 also includes an EGHR assembly 150 including another exhaust conduit 152 and another exhaust conduit 154 arranged in a parallel flow configuration with the exhaust conduit 152. As such, the first and second exhaust conduits merge at an upstream confluence 156 and a downstream confluence 158.

An EGHR heat exchanger 160 is attached to the exhaust conduit 152. The heat exchanger includes a gas inlet 162 and an outlet 164 allowing exhaust gas to flow through the heat exchanger. The heat exchanger 160 also includes coolant conduits (not shown) routed therethrough. The internal coolant conduits are fluidly coupled to coolant conduits routing coolant through the EGHR heat exchanger and to/from an engine cooling system 168. Specifically, in the illustrated example, an outlet coolant conduit 166 routes coolant to passages (e.g., cylinder head and/or block coolant jackets) in the engine 102 from the EGHR heat exchanger 160. An inlet coolant conduit 167 directs coolant into the heat exchanger 160 from another heat exchanger 170 (e.g., cabin heat exchanger). The heat exchanger 170 is fluidly coupled to a flow diverter 171 (e.g., passive crossover flow diverter) designed to adjust the amount of coolant flowing to the heat exchanger 170 or a radiator 172. Thus, flow may be directed to the EGHR heat exchanger from the cabin heat exchanger, for example. For instance, plates, seals, shafts, and/or other suitable mechanical components in the flow diverter 171 may be used to direct coolant flow to the heat exchanger 170 or the radiator 172 based on engine operating conditions, cabin heating requests, etc. In one example, a portion of the coolant from coolant passages in the engine may be directed to both the heat exchanger 170 and the radiator 172. A pump 174 is coupled to the coolant line 175 fluidly connecting the flow diverter 171 and the engine coolant passages. A thermostat 177 may be coupled to a coolant line 179 extending between the flow diverter 171. The thermostat 177 is designed to regulate the engine coolant temperature. Coolant lines 169 direct coolant from the thermostat 177 and the radiator 172 back to the engine coolant passages in the engine. However, it will be appreciated that the engine cooling system 168 may include additional or alternative components, such as valves, filters, etc. Furthermore, coolant routing arrangements differing from the routing illustrated in FIG. 1, have been envisioned.

A first flow control valve 176 is coupled to the exhaust conduit 152. Specifically, in the illustrated example, the first flow control valve 176 is positioned between the gas inlet 162 and the 164 of the EGHR heat exchanger 160 with regard to a downstream exhaust gas flow direction. The first flow control valve 176 is designed to adjust the amount of exhaust gas flow through the first exhaust conduit. For example, the first flow control valve 176 may block the exhaust conduit 152. When the first flow control valve block the first exhaust conduit, exhaust gas is directed through the EGHR heat exchanger 160. On the other hand, the first flow control valve 176 may also be designed to permit exhaust gas flow through the exhaust conduit 152. In this configuration, exhaust gas flow through the EGHR heat exchanger 160 may be substantially inhibited. As such, the first flow control valve 176 may be used to activate/deactivate the EGHR heat exchanger 160. It will be appreciated that the first flow control valve 176 may also be arranged in partially opened or closed configurations where a portion of exhaust gas flows through the EGHR heat exchanger 160 and another portion of exhaust gas flows through the exhaust conduit 152.

A second flow control valve 178 is coupled to the exhaust conduit 154. Specifically, as illustrated, the second flow control valve 178 is positioned at the upstream confluence 156 of the exhaust conduit 152 and the exhaust conduit 154. The first flow control valve 176 and the second flow control valve 178 may include plates, springs, hinges, pivots, bearings, solenoids, other suitable components, etc., facilitating the aforementioned flow control functionality. Examples of the first and second flow control valves are illustrated in detail in FIGS. 6-13 and discussed in greater detail herein.

FIG. 1 also shows a fuel delivery system 138. The fuel delivery system 138 provides pressurized fuel to a fuel injector 140. In the illustrated example, the fuel injector 140 is a direct fuel injector coupled to cylinder 106. Additionally or alternatively, the fuel delivery system 138 may also include a port fuel injector designed to inject fuel upstream of the cylinder 106 into the intake system 104. For instance, the port fuel injector may be an injector with a nozzle spraying fuel into an intake port at desired times. The fuel delivery system 138 includes a fuel tank 142 and a fuel pump 144 designed flow pressurized fuel to downstream components. For instance, the fuel pump 144 may be an electric pump with a piston and an inlet in the fuel tank that draws fuel into the pump and delivers pressurized fuel to downstream components. However, other suitable fuel pump configurations have been contemplated. Furthermore, the fuel pump 144 is shown positioned within the fuel tank 142. Additionally or alternatively the fuel delivery system may include a second fuel pump (e.g., higher pressure fuel pump) positioned external to the fuel tank. A fuel line 146 provides fluidic communication between the fuel pump 144 and the fuel injector 140. The fuel delivery system 138 may include additional components such as a higher-pressure pump, valves (e.g., check valves), return lines, etc., to enable the fuel delivery system to inject fuel at desired pressures and time intervals.

During engine operation, the cylinder 106 typically undergoes a four-stroke cycle including an intake stroke, compression stroke, expansion stroke, and exhaust stroke. During the intake stroke, generally, the exhaust valve closes and intake valve opens. Air is introduced into the combustion chamber via the corresponding intake conduit, and the piston moves to the bottom of the combustion chamber so as to increase the volume within the combustion chamber. The position at which the piston is near the bottom of the combustion chamber and at the end of its stroke (e.g., when the combustion chamber is at its largest volume) is typically referred to by those of skill in the art as bottom dead center (BDC). During the compression stroke, the intake valve and the exhaust valve are closed. The piston moves toward the cylinder head so as to compress the air within the combustion chamber. The point at which the piston is at the end of its stroke and closest to the cylinder head (e.g., when the combustion chamber is at its smallest volume) is typically referred to by those of skill in the art as top dead center (TDC). In a process herein referred to as injection, fuel is introduced into the combustion chamber. In a process herein referred to as ignition, the injected fuel in the combustion chamber is ignited via a spark from an ignition device, resulting in combustion. However, in other examples, compression may be used to ignite the air fuel mixture in the combustion chamber. During the expansion stroke, the expanding gases push the piston back to BDC. A crankshaft converts this piston movement into a rotational torque of the rotary shaft. During the exhaust stroke, in a traditional design, exhaust valve is opened to release the residual combusted air-fuel mixture to the corresponding exhaust passages and the piston returns to TDC.

FIG. 1 also shows a controller 180 in the vehicle 100. Specifically, controller 180 is shown in FIG. 1 as a conventional microcomputer including: microprocessor unit 181, input/output ports 182, read-only memory 183, random access memory 184, keep alive memory 185, and a conventional data bus. Controller 180 is configured to receive various signals from sensors coupled to the engine 102. The sensors may include engine coolant temperature sensor 179, exhaust gas composition sensor 186, exhaust gas airflow sensor 187, an intake airflow sensor 188, manifold pressure sensor 189, engine speed sensor 190, ambient temperature sensor 192, etc. Additionally, the controller 180 is also configured to receive throttle position (TP) from a pedal position sensor 193 coupled to a pedal 194 actuated by an operator 195.

Additionally, the controller 180 may be configured to trigger one or more actuators and/or send commands to components. For instance, the controller 180 may trigger adjustment of the throttle 116, fuel injector 140, fuel pump 144, flow control valves 176 and 178, pump 174, etc. Specifically in one example, the controller 180 may send signals to an actuator in the first and/or second flow control valves that opens and/or closes the valve to facilitate valve adjustment. Furthermore, the controller 180 may be configured to send control signals to actuators in the fuel pump 144 and the fuel injector 140 to control the amount and timing of fuel injection provided to the cylinder 106. The controller 180 may also send control signals to the throttle 116 to vary engine speed. The other adjustable components receiving commands from the controller may also function in a similar manner. Therefore, the controller 180 receives signals from the various sensors and employs the various actuators to adjust engine operation based on the received signals and instructions stored in memory (e.g., non-transitory memory) of the controller. Thus, it will be appreciated that the controller 180 may send and receive signals from the exhaust system 122 and the EGHR assembly 150.

In one specific example, the controller 180 may be designed to implement different exhaust system operating modes. In a first mode exhaust flow through the EGHR heat exchanger 160 may be permitted. In this way, heat may be recovered from the exhaust gas during cold starts, for example, allowing the engine temperature to be increased more rapidly, provide cabin heating, etc. In such an example, at least the second flow control valve 178 may be configured to block the exhaust conduit 154. Additionally, in the first mode, the first flow control valve 176 may be placed in a configuration where the valve blocks (e.g., fully blocks) or partially blocks the exhaust conduit 152 to direct exhaust gas through the EGHR heat exchanger 160. It will be appreciated that the degree to which the valve blocks the exhaust conduit 152 may determine the amount of exhaust gas flowing through the EGHR heat exchanger 160.

Additionally, the controller 180 may be designed to implement a second mode where exhaust gas flow through the EGHR heat exchanger 160 is substantially inhibited and gas flow through the exhaust conduit 152 is permitted. Additionally, in the second mode, exhaust gas flow through the exhaust conduit 154 may be substantially inhibited. Thus, in the second mode the first flow control valve 176 may arrange a valve plate in a position allowing gas to flow through the exhaust conduit 152 and may also block the inlet and/or outlet of the EGHR heat exchanger 160. In this way, the heat exchanger may be deactivated, when desired.

Furthermore, the controller 180 may be designed to implement a third mode where exhaust gas flow through the exhaust conduit 154 is permitted and exhaust gas flow through the exhaust conduit 152 is substantially inhibited. Thus, in the third mode, the second flow control valve 178 may reposition a valve plate to substantially block the exhaust conduit 152. Therefore, in the third mode exhaust gas is directed further away from the EGHR heat exchanger to reduce the amount of heat transferred to the heat exchanger and then the cooling system.

An entry condition for the first mode may be a threshold engine temperature. For instance, when the engine temperature drops below a threshold value (e.g., 60°, 63°, 65°, 70°, 80°, etc.). Conversely, in such an example, the second mode may be implemented when the engine is above the threshold value. Additionally, an entry condition for the third mode may be a threshold engine speed (e.g., 2,500 RPM, 3,000 RPM, 3,500 RPM, etc.,) and/or engine load (e.g., 25 CFM, 50 CFM, 100 CFM, 150 CFM, etc.) It will be appreciated that in some instances, the aforementioned thresholds may be selected based on engine design and EGHR package configuration. As such, the threshold may vary based on the end-use operating environment of the system.

When the engine is above the threshold speed and/or the threshold load the third mode may be implemented. In this way, during high exhaust flow conditions exhaust gas may be routed through a bypass conduit more thermally isolated than the primary conduit. Consequently, the amount of heat transferred to the EGHR heat exchanger during periods of inactivity is reduced to decrease thermal loading on the cooling system. Therefore, parasitic losses in the engine may be reduced during periods of EGHR heat exchanger inactivity. Conversely, when the engine is not operating at a speed and/or load above the threshold value(s) and the engine is above the threshold temperature, the second mode may be implemented. However, other entry condition sets for the different modes have been envisioned. For instance, exhaust manifold pressure, exhaust gas composition, turbine speed in the case of a turbocharged engine, etc. It also will be understood that the aforementioned controller functions may be stored in non-transitory memory that when executed by the processor cause the controller to implement the control commands.

In yet another example, the amount of component, device, actuator, valve, etc., adjustment may be empirically determined and stored in predetermined lookup tables and/or functions. For example, one table may correspond to conditions related to a position of the first flow control valve 176 and another table may correspond to conditions related to a position of the second flow control valve 178. Moreover, it will be appreciated that the controller 180 may be configured to implement the methods, control strategies, etc., described herein.

Referring to FIG. 2, the figure schematically depicts a vehicle 201 with a hybrid propulsion system 200. Hybrid propulsion system 200 includes an internal combustion engine 202. It will be appreciated that the hybrid propulsion system 200 may be included in the vehicle 100 shown in FIG. 1. Thus, the vehicle 201 and the engine 202 shown in FIG. 2 may include at least a portion of the features, components, systems, etc., of the vehicle 100 and engine 102 described above with regard to FIG. 1 or vice versa.

The engine 202 is coupled to a transmission 204. The transmission 204 may be a manual transmission, automatic transmission, or combinations thereof. Further, various additional components may be included, such as a torque converter, and/or other gears such as a final drive unit, etc. The transmission 204 is shown coupled to a drive wheel 206, which in turn is in contact with a road surface 208.

In this example embodiment, the hybrid propulsion system 200 also includes an energy conversion device 210, which may include a motor, a generator, among others and combinations thereof. FIG. 2 also shows an inverter 211 connected to the energy storage device and the energy conversion device. The inverter 211 is configured to condition electrical energy in and out of the energy storage device (e.g., high voltage battery). However, in other examples, the vehicle may not include an inverter. The energy conversion device 210 is further shown coupled to an energy storage device 212, which may include a battery, a capacitor, a flywheel, a pressure vessel, etc. The energy conversion device can be operated to absorb energy from vehicle motion and/or the engine and convert the absorbed energy to an energy form suitable for storage by the energy storage device (i.e., provide a generator operation). The energy conversion device can also be operated to supply an output (power, work, torque, speed, etc.,) to the drive wheel 206 and/or engine 202 (i.e., provide a motor operation). It should be appreciated that the energy conversion device may, in some embodiments, include only a motor, only a generator, or both a motor and generator, among various other components used for providing the appropriate conversion of energy between the energy storage device and the vehicle drive wheel and/or engine.

The depicted connections between engine 202, energy conversion device 210, transmission 204, and drive wheel 206 indicate transmission of mechanical energy from one component to another, whereas the connections between the energy conversion device and the energy storage device may indicate transmission of a variety of energy forms such as electrical, mechanical, etc. For example, torque may be transmitted from engine 202 to drive the vehicle drive wheel 206 via transmission 204. As described above energy storage device 212 may be configured to operate in a generator mode and/or a motor mode. In a generator mode, the hybrid propulsion system 200 absorbs some or all of the output from engine 202 and/or transmission 204, which reduces the amount of drive output delivered to the drive wheel 206, or the amount of braking torque to the drive wheel 206. Such operation may be employed, for example, to achieve efficiency gains through regenerative braking, increased engine efficiency, etc. Further, the output received by the energy conversion device may be used to charge energy storage device 212. In the motor mode, the energy conversion device may supply mechanical output to engine 202 and/or transmission 204, for example, by using electrical energy stored in an electric battery.

Hybrid propulsion embodiments may include full hybrid systems, in which the vehicle can run on just the engine, just the energy conversion device (e.g., motor), or a combination of both. Assist or mild hybrid configurations may also be employed, in which the engine is the primary torque source, with the hybrid propulsion system acting to selectively deliver added torque, for example during tip-in or other conditions. Further still, starter/generator and/or smart alternator systems may also be used. The various components described above with reference to FIG. 2 may be controlled by a vehicle controller such as the controller 180, shown in FIG. 1.

From the above, it should be understood that the exemplary hybrid propulsion system 200 is capable of various modes of operation. In a full hybrid implementation, for example, the propulsion system may operate using energy conversion device 210 (e.g., an electric motor) as the only torque source propelling the vehicle. This “electric only” mode of operation may be employed during braking, low speeds, while stopped at traffic lights, etc., in one example. However, in other examples the “electric only” mode may be implemented over a wider range of operating conditions such as at higher speeds. In another mode, engine 202 is turned on, and acts as the only torque source powering drive wheel 206. In still another mode, which may be referred to as an “assist” mode, energy conversion device 210 may supplement and act in cooperation with the torque provided by engine 202. As indicated above, energy conversion device 210 may also operate in a generator mode, in which torque is absorbed from engine 202 and/or transmission 204. Furthermore, energy conversion device 210 may act to augment or absorb torque during transitions of engine 202 between different combustion modes (e.g., during transitions between a spark ignition mode and a compression ignition mode). Additionally, an external energy source 214 may provide power to the energy storage device 212. The external energy source 214 may be a charging station outlet or other suitable power outlet, a solar panel, a portable energy storage device, etc., for instance.

FIG. 3-5 show an example of an EGHR assembly 300 in an exhaust system 302 in different operating modes. It will be appreciated that the EGHR assembly 300, the exhaust system 302, and/or corresponding components, depicted in FIGS. 3-5, may be examples of the EGHR assembly 150, the exhaust system 122, and/or the corresponding components, shown in FIG. 1. As such, different structural and/or functional features of the EGHR assemblies and the exhaust systems may be combined, substituted, etc., to form other assembly/system embodiments. Additionally, the components described with regard to FIGS. 3-5 as well as FIGS. 6-16 may be controller by a controller, such as the vehicle controller 180, shown in FIG. 1.

FIG. 3 shows the EGHR assembly 300 with a first exhaust conduit 304. The first exhaust conduit 304 may receive exhaust gas from upstream exhaust system components such as an exhaust manifold, cylinder(s), etc.

A second exhaust conduit 306 is coupled in a parallel flow arrangement with the first exhaust conduit 304. As described herein a parallel flow arrangement is an arrangement where two conduits include sections fluidly separated from one another between an upstream and downstream intersection and flow fluid in a common general direction. As such, the first and second exhaust conduits 304 and 306 merge at an upstream confluence 308 and a downstream confluence 310.

An EGHR heat exchanger 312 is coupled to an exterior surface 313 of the first exhaust conduit 304. In the illustrated example, a housing 314 of the EGHR heat exchanger 312 is coupled to the first exhaust conduit 304 via a gas inlet 316 and a gas outlet 318. Specifically, as illustrated, the inlet 316 and outlet 318 extend through a housing 319 of the first exhaust conduit 304 and open into an interior flow channel 321 of the conduit. However, in other examples, the heat exchanger housing 314 may be directly coupled an exterior surface 313 of the first exhaust conduit 304. The EGHR heat exchanger 312 includes a coolant inlet conduit 320 and a coolant outlet conduit 322. Therefore, the EGHR heat exchanger 312 may also include coolant passages routing coolant through the heat exchanger to remove heat therefrom. As previously discussed, the coolant from the heat exchanger 312 may be routed to an engine cooling system, such as the engine cooling system 168, shown in FIG. 1. In one particular example, the heat extracted from the EGHR heat exchanger 312 may be routed to a cabin heat exchanger. In this way, additional heat may be provided to the cabin (during cold starts, for instance). However, other coolant routing arrangements in the cooling system may be used, in other instances.

The first and second exhaust conduits 304 and 306 each include bodies 324 between the upstream confluence 308 and the downstream confluence 310 of the first and second exhaust conduits 304 and 306. As shown, the bodies 324 of the conduits are spaced away from one another. Specifically, a gap 326 is formed between the bodies 324, in the depicted example. In this way, heat transferred from the second exhaust conduit to the first exhaust conduit may be decreased. However, in other examples, the housings of the first and second exhaust conduits may be at least partially attached along their lengths.

A first flow control valve 328 is also depicted in FIG. 3. The first flow control valve 328 is an example of the first flow control valve 176, shown in FIG. 1. The first flow control valve 328 is positioned in the first exhaust conduit 304 between the inlet 316 and outlet 318 of the EGHR heat exchanger 312. However, other valve positions and/or configurations have been envisioned. For instance, a first valve may be positioned upstream of the heat exchanger inlet 316 and downstream of the upstream confluence and a second valve may be located at the inlet. In the depicted embodiment, the first flow control valve 328 includes a plate 330 rotating about a pivot 332 at one end. The plate 330 may be profiled to obstruct gas flow, in selected positions. However, other valve designs may be used in other embodiments such as butterfly valves, solenoid valves, flap valves, spring driven valves with wax actuators, etc.

A second flow control valve 334, is also shown in FIG. 3. The second flow control valve 334 is an example of the second flow control valve 178, shown in FIG. 1. The second flow control valve 334 is positioned in the upstream confluence 308 between the first and second exhaust conduits. However, in other examples, the second flow control valve 334 may be positioned at a downstream location in the second exhaust conduit 306 between the upstream and downstream confluence of the conduits. Again, the second flow control valve 334 also includes a plate 336 rotating about a pivot 338 at one end and the plate 336 may be profiled to obstruct gas flow, in selected positions. However, other valve designs such as the valve designs listed above regarding the first flow control valve may be used, in other embodiments. The second flow control valve 334 is also shown including a spring-loaded flap 340 (e.g., pressure actuated flap). The spring-loaded flap 340 may open when the pressure in the first exhaust conduit 304 exceeds a threshold pressure (e.g., a range between 6 kPa and 28 kPa, 10 kPa, 20 kPa, 28 kPa, etc.) The threshold may be determined as a product of gas temperature, flowrate, and/or a function of engine size and package location (e.g., whether the exhaust system includes a one or two bank manifold), for instance. In this way, the chance of overpressure conditions in the first exhaust conduit 304 may be reduced when, for example, the EGHR heat exchanger is activated. Detailed illustrations of the second flow control valve 334 are depicted in FIGS. 6-7.

As shown in FIG. 6 the second flow control valve 334 includes the plate 336 and the flap 340 partially extending across the plate. The flap 340 rotates about a spring-loaded pivot 600. In this way, the flap 340 may open when the pressure in the first exhaust conduit 304, shown in FIG. 3, exceeds the spring force. However, other suitable passive valving arrangements allowing for over pressure conditions to be avoided may be used, such as check valves. Still further in other examples, active valve components may be used to reduce the likelihood of overpressure conditions. Additionally, the flap has a semi-circular shape, in the illustrated example. However, numerous suitable flap shapes have been envisioned such as polygonal shapes, circular shapes, oval shapes, etc.

FIG. 7 illustrates a side view of the second flow control valve 334. Again, the plate 336 and flap 340 are depicted. A rotational axis 700 of the spring-loaded pivot 600 is also depicted in FIG. 7. The flap's actuation path 702 (e.g., arc) is shown to exemplify flap movement from an open position to a closed position. It will be appreciated that gas flows through a central region of the flap when it is in the open position and conversely when it is closed gas is inhibited from flowing through the central flap region.

FIGS. 8-9 show a different example of a flow control valve 800. The flow control valve 800 may an example of the second flow control valve 334, shown in FIG. 3. The flow control valve 800 includes a first section 802 and a second section 804. A torsion spring 806 is coupled to the first section 802 and the second section 804. The torsion spring 806 is designed to allow the second section 804 to pivot and allow gas flow into the branch exhaust conduit, such as the second exhaust conduit 306, shown in FIG. 3. The torsion spring 806 may function in this manner when a threshold pressure (e.g., 6 kPa-28 kPa, 10 kPa, 20 kPa, 28 kPa, etc.,) in the first exhaust conduit, such as the first exhaust conduit 304, shown in FIG. 3, exceeds the threshold pressure. In this way, the flow control valve 800 passively allows exhaust gas flow through the first and second exhaust conduits, during certain engine operating conditions. FIG. 9 also shows the pivot point 900 of the second section 804 and a path 902 of the second section 804 during actuation.

FIGS. 10-11 show different views of another example of a flow control valve 1000. Thus, the flow control valve 1000 may be the first flow control valve 328, shown in FIG. 3, in some examples.

FIG. 10 shows a side view of the flow control valve 1000 in an exhaust conduit 1002 with housing 1004 enclosing an exhaust airflow. Arrow 1006 depicts the general direction of exhaust gas flow through the conduit 1002. The flow control valve 1000 includes a spring 1008 (e.g., toroid spring). The spring 1008 and the plate 1012 rotate about a hinge 1013. The spring's torque direction is indicated by arrow 1010. Thus, the spring action urges the valve into a closed position. However, other valve designs may be used, in other examples. The spring 1008 is coupled to a flow direction plate 1012. The flow direction plate 1012 allows the valve to block exhaust flow through the conduits in some positions and in other positions allows exhaust gas to flow through the exhaust conduit. A lever 1014 is also coupled to the spring 1008. The lever 1014 is coupled to a wax actuator 1016 via a pin 1017 or other suitable mechanical coupling in a groove 1019 of the lever. The wax actuator 1016 designed to actuate the level 1014 based on the temperature of coolant flowing through the actuator. For instance, the wax actuator 1016 may be designed to actuate the lever 1014 to move the plate 1012 into a position where exhaust gas is allowed to flow through the conduit 1012 when the coolant temperature is above a threshold value (e.g., 55° C. to 85° C., 60° C., 63° C., 70° C., etc.) Continuing with such an example, the wax actuator 1016 may be designed to actuate the lever to move the plate into a position obstructing exhaust gas flow through the conduit when the coolant temperature is below the threshold value. In this way, the wax valve opens at a predetermined temperature and stays open as long as the coolant temperature stays above the predetermined temperature. However, other valve designs have been envisioned such as valves designed with active control schemes.

The wax actuator 1016 is shown including a coolant inlet 1018 and a coolant outlet 1020. Thus, the coolant inlet receives coolant from the engine's cooling system, such as the cooling system 168, shown in FIG. 1, and the coolant outlet expels coolant into the engine cooling system. A base 1022 (e.g., welded base) is also shown coupled to the wax actuator 1016. The base 1022 is attached to the housing 1004 of the conduit 1002.

FIG. 11 shows a front view of the flow control valve 1000. Again the plate 1012, the spring 1008, the hinge 1013, the lever 1014, the wax actuator 1016, the coolant inlet 1018, the coolant outlet 1020, and the base 1022.

FIGS. 12-13 show another example of a flow control valve 1200. The flow control valve 1200 is an example of the first flow control valve 328, shown in FIG. 3. The flow control valve 1200 includes a wax actuator 1202 with a coolant inlet 1204 and outlet 1206. Thus, the wax actuator 1202 receives coolant from an engine cooling system, such as the cooling system 168, shown in FIG. 1. The coolant flow through the wax actuator initiates valve actuation in the valve when the coolant temperature surpasses a threshold value or threshold range. An output shaft 1207 of the wax actuator 1202 is coupled to a flow plate 1208 via mechanical linkage 1210. The mechanical linkage 1210 includes a gear 1212 rotationally coupled to the output shaft 1207 via a lever 1213. The mechanical linkage 1210 also includes a shaft 1214 (e.g., serrated shaft) attached to the flow plate 1208 and the gear 1212. The shaft 1214 is spring loaded via a torsion spring 1300, shown in FIG. 13. The direction of spring loading of the shaft 1214 is indicated via arrow 1216. In one specific example, the wax actuator 1202 may expand to push the shaft 1207 in an axial direction to actuate the mechanical linkage 1210, thereby opening the valve to allow exhaust gas flow through the exhaust conduit 1222 and prevent exhaust gas flow through the EGHR heat exchanger inlet passage 1224. It will be appreciated that the valve 1200 may stay open as long as the coolant temperature stays above the threshold value. However, when the coolant temperature decreasing the torsion spring 1300, shown in FIG. 13, gradually compresses the wax back into a reservoir, causing the plate 1208 to block gas flow in the conduit 1222. In this way, the valve allows gas to flow through the EGHR inlet when the engine coolant temperature is below a desired value. However, other valve actuation designs have been contemplated. Arrow 1226 depicts the general flow of exhaust gas in an upstream portion of the conduit 1222.

Additionally, a spring loaded door 1218 is coupled to the flow plate 1208. Specifically, a spring 1220 is coupled to the spring loaded door 1218 and the flow plate 1208. The spring loaded door 1218 opens and allows exhaust gas to flow through exhaust conduit 1222 when the pressure in the exhaust conduit exceeds a threshold value (e.g., 6 kPa-28 kPa, 10 kPa, 20 kPa, etc.) Arrow 1226 indicates the direction of rotation of the door 1218 when moving into a position allowing gas to pass downstream through the conduit 1222. In this way, when engine speed increases the valve 1200 opens to reduce the likelihood of overpressure conditions in the exhaust conduit.

FIG. 13 shows a rear view of the flow control valve 1200. The spring 1300 (e.g., torsion spring) coupled to the flow plate 1208 via a hinge 1302 is shown in FIG. 13. The wax actuator 1202 is also shown in FIG. 13. The wax actuator 1202 includes a welded plate 1304 and as previously discussed a coolant inlet 1204 and a coolant outlet 1206. The lever 1213 in the mechanical linkage 1210 is also shown in FIG. 13. The springs 1306 interacting with the door 1218, are also shown in FIG. 13. As previously discussed, the springs 1306 function to allow the door to rotate and allow exhaust gas pass through the conduit 1222, shown in FIG. 12, when the pressure in the conduit exceeds the threshold value. The springs 1306 are positioned on lateral sides of the door, but other positions of the springs have been contemplated.

Returning to FIG. 3, the EGHR assembly 300 and exhaust system 302 are depicted in first operating mode (e.g., active mode) where the first flow control valve 328 directs exhaust gas through the EGHR heat exchanger 312 and blocks flow through the first exhaust conduit 304. Additionally, in the first mode the second flow control valve 334 is shown blocking the second exhaust conduit 306. Additionally, in the first mode of operation the first flow control valve 328 and/or second flow control valve 334 may be partially opened to modulate exhaust flow through the EGHR heat exchanger 312. Arrows 350 depict the general flow direction of exhaust gas in the system. However, it will be appreciated that the actual flow patterns in the exhaust system have greater complexity than is depicted.

FIG. 4, shows the EGHR assembly 300 and the exhaust system 302 in a second operating mode (e.g., lower flow bypass mode) and FIG. 5 shows the EGHR assembly 300 and the exhaust system 302 in a third operating mode. The EGHR assembly 300 and exhaust system 302 are shown in FIGS. 4 and 5.

Referring specifically to FIG. 4, in the second operating mode the first flow control valve 328 is positioned to permit exhaust gas flow through the first exhaust conduit 304. Additionally, as illustrated in FIG. 4 the plate 330 of the first flow control valve 328 substantially blocks (e.g., completely blocks) the outlet of the heat exchanger 312. However, in other examples, the first flow control valve 328 may block the inlet of the heat exchanger or the plate may not block the heat exchanger outlet or inlet. Additionally, as shown in FIG. 4 the second flow control valve 334 blocks the second exhaust conduit 306. As such exhaust gas travels through the first exhaust conduit 304. Arrows 450 depict the general direction of exhaust gas flow in FIG. 4.

Referring specifically to FIG. 5, in the third operating mode, the second flow control valve 334 is positioned to block exhaust gas flow through the first exhaust conduit 304 and permits exhaust gas flow through the second exhaust conduit 306. In this way, exhaust gas flow may be routed further away, with regard to conduit housing material, from the EGHR heat exchanger 312. Consequently, the amount of heat transferred to the EGHR heat exchanger during the third mode may be reduced. It will be appreciated that coolant may be routed through the EGHR heat exchanger 312 in the second and/or third operating modes. Arrows 550 depict the general direction of exhaust gas flow in FIG. 5. It will be appreciated, that the second flow control valve 334 may also function as a back-up with regard to the first flow control valve 328 malfunctions (e.g., fails), in certain circumstances.

FIGS. 14 and 15 show different examples of exhaust systems with EGHR heat exchangers with insulated unions in different locations in the system. It will be appreciated that one or more of the functional and/or structural features of the previously described exhaust systems may be included in the exhaust systems depicted in FIGS. 3-5 or vice versa.

Specifically, FIG. 14 shows an EGHR assembly 1400 with insulated unions 1402 at locations upstream and downstream of an inlet 1404 and an outlet 1406 of the EGHR heat exchanger 1408. The insulated unions reduce the amount of heat transferred from a housing 1410 of the exhaust conduit 1412 to the EGHR heat exchanger 1408. Consequently, the insulated unions provide greater thermal isolation to the heat exchanger to reduce heat transfer to the device shutdown. The insulated unions may therefore include insulation material at least partially circumferentially surrounding the exhaust conduit acting as an insulative interface between different sections of the conduit's housing. FIG. 14 also shows the coolant conduits 1414 routed through a housing 1416 of the EGHR heat exchanger 1408. Coolant inlets and outlets 1418 connect the heat exchanger to an engine cooling system, such as the cooling system 168, shown in FIG. 1. The coolant conduits 1414 laterally traverse the housing. However, numerous types of suitable heat exchanger types may be used such as counter-flow heat exchangers, shell and tube heat exchangers, etc. Arrows 1450 depict the general direction of coolant flow into and out of the heat exchanger 1408. Arrows 1452 depict the general direction of exhaust gas flow through the EGHR assembly 1400. As shown, a flow control valve 1420 is blocking an exhaust conduit 1422 to induce gas flow into the EGHR heat exchanger 1408.

FIG. 15 shows an EGHR assembly 1500 similar to the EGHR assembly 1400, depicted in FIG. 14. Therefore, redundant description is omitted for brevity. The EGHR assembly 1500, shown in FIG. 15, includes insulated unions 1502 at the inlet 1504 and the outlet 1506 of the EGHR heat exchanger 1508. In this way, the thermal isolation of the EGHR heat exchanger 1508, when inactive, may be further increased, when compared to the EGHR assembly, shown in FIG. 14.

FIG. 15 also shows a flow control valve 1510 in a configuration blocking the inlet 1504. As such, gas flow through the exhaust conduit 1512 is permitted and gas flow through the heat exchanger 1508 is substantially inhibited. The general flow pattern of gas through the exhaust conduit is indicated at 1514. Arrows 1516 also indicate the general direction of coolant flow through the heat exchanger 1508. It will be appreciated that in one example, coolant may be continuously flowed through the heat exchanger 1508 regardless of the position of the flow control valve 1510. As such, coolant may be flowed through the heat exchanger while it is shut down and exhaust gas is substantially prevented from flowing therethrough, in some embodiments.

FIG. 16 shows a cross-sectional view of an example of an insulation union 1502 in the EGHR assembly 1500, depicted in FIG. 15. FIG. 16 specifically shows the insulated union 1502 at the inlet 1504 of the EGHR heat exchanger. However, the other unions in the EGHR assembly may have a similar configuration, in some instances. The insulated union 1502 may include an insulated ring 1602 and a clamp 1604 designed to exert compressive force on the union. The insulated ring 1602 may specifically be in the shape of a donut, in one example. Thus, the insulation ring 1602 may circumferentially surround the EGHR heat exchanger inlet. However, other shapes of the ring have been contemplated. Additionally, in one example, the clamp 1604 may be constructed out of a metal such as stainless steel. Sections 1606 connect the union to the EGHR main body and the EGHR heat exchanger 1508, shown in FIG. 15. Section 1609 connects to the housing of the conduit 1512, shown in FIG. 15. The EGHR main body may be constructed out of a metal such as stainless steel, for instance. In some examples, the unions may be constructed out of Alumina (Al2O3) or Silicon Nitride (Si3N4), combinations thereof, etc. The insulated unions may be particularly beneficial with regard to reducing heat transfer to the heat exchanger when the exhaust conduit housing is constructed out of metal or other material with high thermal conductivity.

Arrow 1650 depicts the general direction of exhaust gas flow through the inlet 1504 of the EGHR heat exchanger. It will be appreciated that due to the configuration of the insulated union a decreased amount of heat may be transferred from the exhaust conduit's housing to the EGHR heat exchanger. As a result, parasitic losses in the system when the EGHR heat exchanger is shutdown are reduced.

Sections 1608 may provide additional insulation in the union. The sections 1608 may be in the shape of half-moons, in one example. However, other shapes of sections 1608 have been envisioned. Sections 1610 may also be in the shape of a half-moon, in some examples. Section 1610 may be constructed out of a metal such as stainless steel, in some instances.

FIGS. 1-16 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

FIG. 17 shows a method 1700 for operation of an exhaust system with an EGHR assembly. The method 1700 as well as the remainder of the methods described herein may be implemented via the exhaust systems, EGHR assemblies, components, etc., described above with regard to FIGS. 1-16. However, in other examples, the method 1700 and/or the other methods described herein may be implemented via other suitable exhaust systems and EGHR assemblies. Instructions for carrying out method 1700 may be executed by a controller based on instructions stored in non-transitory memory of the controller.

At 1702 the method includes determining operating conditions that may include engine speed, engine temperature, engine load, ambient temperature, exhaust gas airflow, MAP, etc. Next at 1704 the method includes determining an exhaust system operating mode using the operating conditions. At 1706 the method includes implementing a first operating mode in which a first valve is adjusted to direct exhaust gas flow through the EGHR heat exchanger at 1708 and a second valve is adjusted to block exhaust gas flow through the second exhaust conduit at 1710. The entry conditions for the first mode may include a condition where engine temperature is below a threshold value (e.g., 60°, 63°, 65°, 70°, 80°, etc.,) in one example. However, other suitable entry conditions may be used, such as engine load. The first operating mode may also include a step of opening (e.g., passively opening) the flap in the second valve to reduce backpressure (e.g., sudden backpressure) in the exhaust stream.

At 1712 the method includes implementing a second operating mode where the first valve is adjusted to permit exhaust gas flow through the first exhaust conduit at 1714 and where the second valve is adjusted to block exhaust gas flow through the second exhaust conduit at 1716. In this way, the operation of the EGHR heat exchanger may be shut down and exhaust gas may be directed through the first exhaust conduit. The entry conditions for the second mode may include a condition where engine temperature is above a threshold value and the engine speed is below a threshold value (e.g., 3,000-6,000 RPM, 3,000 RPM, 4,000 RPM, etc.) In this way, when the EGHR heat exchanger is shut down and the engine is operating at a low speed, exhaust gas may be directed through the first exhaust conduit. Thus, exhaust gas is directed through the first exhaust conduit when the amount of heat transferred from the exhaust gas to the heat exchanger is below a desired value due to the lower exhaust gas flowrate. The second operating mode may also include a step of opening (e.g., passively opening) the flap in the second valve to reduce backpressure (e.g., sudden backpressure) in the exhaust stream.

At 1716 the method includes implementing a third operating mode where the method includes adjusting the first valve to inhibit exhaust gas flow through the first exhaust conduit at 1718 and adjusting the second valve to permit exhaust gas flow through the second exhaust conduit at 1720. The entry conditions for the third mode may include a condition where engine temperature is above a threshold value and the engine speed is above the threshold value. In this way, heat transfer from the exhaust gas to the EGHR heat exchanger may be reduced because the exhaust gas is routed further away from the heat exchanger. Consequently, parasitic losses in the engine can be reduced due to the decrease thermal load on the engine cooling system. It will be appreciated, that the different operating modes may be transitioned between depending on the operating conditions. As such, one mode is implemented while the other modes are temporarily disabled. In the third operating mode the second flow control valve may also be configured to inhibit the flap in the valve from opening, in some examples. Thus, the third operating mode may include the step of inhibiting (e.g., passively inhibiting) a flap in the second flow control valve from opening.

In another example operating strategy the first flow control valve may be held closed and the EGHR heat exchanger may be continuously in an active mode until a threshold engine coolant temperature (e.g., maximum engine coolant temperature (e.g., approximately 88 degrees Celsius)) is reached. At that point the second flow control valve may be opened. Therefore, backpressure may be handled by the second flow control valve.

FIG. 18 shows another method 1800 for operating an exhaust system. At 1802 the method includes determining operating conditions, similar to step 1702, shown in FIG. 17. Next at 1804 the method includes determining if the engine is operating below a threshold temperature (e.g., 60 degrees Celsius, 63 degrees Celsius, 70 degrees Celsius, etc.)

If it is determined that the engine is operating below the threshold temperature (YES at 1804) the method includes implementing the first operating mode at 1806. Implementing the first mode includes steps 1808-1810 similar to steps 1708-1710, shown in FIG. 17. In this way, exhaust heat may be captured by the heat exchanger to warm up the engine, provide cabin heating, etc., during a cold-start, for instance.

On the other hand, if it is determined that the engine is not operating below the threshold temperature (NO at 1804) the method moves to 1812. At 1812 the method includes determining if the engine speed is above a threshold value.

If it is determined that the engine speed is not above the threshold value (NO at 1812) the method advances to 1814 where the method includes implementing the second operating mode. Implementing the second operating mode includes steps 1816-1818, similar to steps 1714-1716, shown in FIG. 17. Thus, in the second mode the EGHR heat exchanger is deactivated and exhaust gas is routed through the first exhaust conduit.

Conversely, if it is determined that the engine speed is above the threshold value (YES at 1814) the method moves to 1820 where the method includes implementing the third operating mode. The third operating mode includes steps 1822-1824 similar to steps 1718-1720, shown in FIG. 17. As previously, discussed when the third operating mode is implemented parasitic losses in the engine are decreased, thereby increasing engine efficiency.

Now turning to FIG. 19, depicting examples of pressure graphs and control signal graphs during an exhaust system control routine, such as the exhaust systems and control methods described above with regard to FIGS. 1-18. The example of FIG. 19 is drawn substantially to scale, even though each and every point is not labeled with numerical values. As such, relative differences in timings can be estimated by the drawing dimensions. However, other relative timings may be used, if desired. Furthermore, in each of the graphs time is represented on the abscissa. Additionally, the graphical control strategy of FIG. 19 is illustrated as a use case example and that numerous control strategies for the exhaust systems described herein, have been contemplated.

A temperature plot is indicated at 1900 and an engine speed is indicated at 1902. An engine temperature threshold value 1904 and an engine speed threshold value 1906. Surpassing the engine temperature threshold value 1904 may trigger a transition between the previously described first and second exhaust system operating modes or vice versa. Furthermore, surpassing the engine speed threshold may trigger a transition from the previously described second and third operating modes or vice versa.

A first valve control signal is indicated at 1908. Signals blocking the first exhaust conduit and unblocking the first exhaust conduit are indicated on the ordinate. A second valve control signal is indicated at 1910. Signals blocking the first exhaust conduit and blocking the second exhaust conduit are indicated on the ordinate.

At t0, the first flow control valve is configured to block the first exhaust conduit and the second flow control valve is configured to block the second exhaust conduit. In this way, the EGHR heat exchanger is in an active mode recovering heat from the exhaust.

As shown, at t1 the engine temperature surpasses the threshold value and in response the second control valve is reconfigured to block the second exhaust conduit and the first control valve is reconfigured to unblock the first exhaust conduit.

At t2 the engine speed surpasses the threshold value and in response the second flow control valve is switched into a configuration where the first exhaust conduit is blocked. In this way, hot exhaust gas is routed further away from the EGHR heat exchanger to reduce heat transfer thereto during high exhaust flow conditions. As a result, the thermal loading on the engine cooling system during periods of EGHR heat exchanger inactivity is reduced.

The technical effect of providing an exhaust system with two conduits in a parallel flow arrangement and an EGHR heat exchanger coupled to one of the conduits with valving designed to vary the flow in each conduit is that the EGHR heat exchanger may be more efficiently operated during selected operating conditions and also that heat transferred to the EGHR heat exchanger during other operating conditions may be reduced, thereby decreasing thermal loading of the cooling system.

The invention will be further described in the following paragraphs. In one aspect, an exhaust system for an internal combustion engine is provided that comprises: a first exhaust conduit receiving exhaust gas from a cylinder during internal combustion engine operation; an EGHR heat exchanger coupled to an exterior surface of the first exhaust conduit and including an inlet and an outlet extending through a housing of the first exhaust conduit; a second exhaust conduit arranged in a parallel flow arrangement with the first exhaust conduit and including a conduit body spaced away from the first exhaust conduit; a first flow control valve coupled to the first exhaust conduit and designed to adjust exhaust gas flow through the EGHR heat exchanger; and a second flow control valve coupled to the second exhaust conduit and designed to adjust exhaust gas flow through the second exhaust conduit.

In another aspect, a method for operating an exhaust system is provided that comprises implementing a first operating mode where a first flow control valve positioned in a first exhaust conduit is adjusted to flow exhaust gas through an EGHR heat exchanger from an inlet extending through a housing of the first exhaust conduit and a second flow control valve positioned in a second exhaust conduit is adjusted to inhibit exhaust gas flow through the second exhaust conduit. In one example, the method may further include implementing a second operating mode where the first flow control valve positioned in the first exhaust conduit is adjusted to inhibit exhaust gas through the EGHR heat exchanger coupled to the first exhaust conduit and the second flow control valve positioned in the second exhaust conduit is adjusted to inhibit exhaust gas flow through the second exhaust conduit. Further, in one example, the method may include implementing a third operating mode where the second flow control valve positioned in the second exhaust conduit is adjusted to permit exhaust gas flow through the second exhaust conduit and inhibit exhaust gas flow through the first exhaust conduit.

In another aspect, an exhaust system for an internal combustion engine is provided that comprises a first exhaust conduit receiving exhaust gas from a cylinder during internal combustion engine operation; an EGHR heat exchanger coupled to an exterior surface of the first exhaust conduit and including an inlet and an outlet extending through a housing of the first exhaust conduit; a second exhaust conduit arranged in a parallel flow arrangement with the first exhaust conduit and including a conduit body spaced away from the first exhaust conduit; a first flow control valve positioned within the first exhaust conduit and adjusting exhaust gas flow through the EGHR heat exchanger; a second flow control valve coupled to the second exhaust conduit and adjusting exhaust gas flow through the second exhaust conduit; and a controller with computer readable instructions stored on non-transitory memory that when executed during an engine-off condition, cause the controller to; operate the exhaust system in a first mode where exhaust gas flow through the EGHR heat exchanger is permitted and exhaust gas flow through the second exhaust conduit is inhibited by adjusting the first and second flow control valves; and operate the exhaust system in a second mode where exhaust gas flow through the EGHR heat exchanger is inhibited and exhaust gas flow through the second exhaust conduit is permitted by closing the first flow control valve and opening the second flow control valve.

In any of the aspects or combinations of the aspects, the exhaust system may further comprise a controller with computer readable instructions stored on non-transitory memory that when executed cause the controller to; operate the exhaust system in a first mode where exhaust gas flow through the EGHR heat exchanger is permitted and exhaust gas flow through the second exhaust conduit is inhibited by adjusting the first and second flow control valves.

In any of the aspects or combinations of the aspects, the controller may further include computer readable instructions stored on the non-transitory memory that when executed cause the controller to; operate the exhaust system in a second mode where exhaust gas flow through the EGHR heat exchanger is inhibited and exhaust gas flow through the second exhaust conduit is permitted by adjusting the first and second flow control valves.

In any of the aspects or combinations of the aspects, the second mode may be implemented when exhaust gas flow through the first exhaust conduit exceeds a threshold value.

In any of the aspects or combinations of the aspects, the controller may further include computer readable instructions stored on the non-transitory memory that when executed cause the controller to; operate the exhaust system in a third mode where exhaust gas flow through the EGHR heat exchanger is inhibited and exhaust gas flow through the second exhaust conduit is permitted by adjusting the first and/or second flow control valves.

In any of the aspects or combinations of the aspects, the EGHR heat exchanger may include an insulated union positioned in at least one of the inlet and the outlet of the EGHR heat exchanger.

In any of the aspects or combinations of the aspects, the second flow control valve may include a pressure-actuated flap designed to open when a pressure in the first exhaust conduit exceeds a threshold value.

In any of the aspects or combinations of the aspects, the exhaust system may further comprise an insulated joint in the first exhaust conduit upstream of the EGHR heat exchanger inlet and an upstream confluence between the first exhaust conduit and the second exhaust conduit.

In any of the aspects or combinations of the aspects, the first exhaust conduit may be fluidly coupled to the second exhaust conduit in a parallel flow configuration and where the first exhaust conduit includes a body spaced away from a body of the second exhaust conduit.

In any of the aspects or combinations of the aspects, the second operating mode may be implemented responsive to an exhaust gas flow through the first exhaust conduit exceeding a threshold value.

In any of the aspects or combinations of the aspects, during implementation of the first operating mode, a pressure-actuated flap in the second flow control valve may be passively opened responsive to a pressure in the first exhaust conduit exceeding a threshold value.

In any of the aspects or combinations of the aspects, the third operating mode may be transitioned into responsive to an exhaust gas flow through the first exhaust conduit being less than a threshold value.

In any of the aspects or combinations of the aspects, the first operating mode may be transitioned into responsive to a temperature of the internal combustion engine coolant being below a threshold value.

In any of the aspects or combinations of the aspects, the controller may further include computer readable instructions stored on the non-transitory memory that when executed cause the controller to; operate the exhaust system in a third mode where exhaust gas flow through the EGHR heat exchanger is inhibited and exhaust gas flow through the second exhaust conduit is permitted by adjusting the first and second flow control valves.

In any of the aspects or combinations of the aspects, the second flow control valve may include a flap passively opening when pressure in the first exhaust conduit exceeds a threshold value.

In any of the aspects or combinations of the aspects, the exhaust system may further comprise an EGHR insulated union at each of the inlet and the outlet of the EGHR heat exchanger and an exhaust conduit insulated joint in the first exhaust conduit upstream of the EGHR heat exchanger inlet and an upstream confluence between the first exhaust conduit and the second exhaust conduit.

In any of the aspects or combinations of the aspects, the exhaust system may be included in a hybrid vehicle.

In another representation, an EGHR assembly is provided with parallel flow conduits and a heat exchanger directly coupled to one of the conduits and flow control valves routing exhaust gas through the flow conduits spaced away from the heat exchanger during selected operating conditions to reduce heat transfer to the EGHR heat exchanger.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the terms “approximately” and “substantially” are construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An exhaust system for an internal combustion engine, comprising:
a first exhaust conduit receiving exhaust gas from a cylinder during internal combustion engine operation;
an exhaust gas heat recovery (EGHR) heat exchanger coupled to an exterior surface of the first exhaust conduit and including an inlet and an outlet extending through a housing of the first exhaust conduit;
a second exhaust conduit arranged in a parallel flow arrangement with the first exhaust conduit and including a conduit body spaced away from the first exhaust conduit;
a first flow control valve coupled to the first exhaust conduit and designed to adjust exhaust gas flow through the EGHR heat exchanger; and
a second flow control valve coupled to the second exhaust conduit and designed to adjust exhaust gas flow through the second exhaust conduit.

2. The exhaust system of claim 1, further comprising a controller with computer readable instructions stored on non-transitory memory that when executed cause the controller to;
operate the exhaust system in a first mode where exhaust gas flow through the EGHR heat exchanger is permitted and exhaust gas flow through the second exhaust conduit is inhibited by adjusting the first and second flow control valves.

3. The exhaust system of claim 2, where the controller further includes computer readable instructions stored on the non-transitory memory that when executed cause the controller to;
operate the exhaust system in a second mode where exhaust gas flow through the EGHR heat exchanger is inhibited and exhaust gas flow through the second exhaust conduit is permitted by adjusting the first and second flow control valves.

4. The exhaust system of claim 3, where the second mode is implemented when exhaust gas flow through the first exhaust conduit exceeds a threshold value.

5. The exhaust system of claim 4, where the controller further includes computer readable instructions stored on the non-transitory memory that when executed cause the controller to;
operate the exhaust system in a third mode where exhaust gas flow through the EGHR heat exchanger is inhibited and exhaust gas flow through the second exhaust conduit is permitted by adjusting the first and/or second flow control valves.

6. The exhaust system of claim 1, where the EGHR heat exchanger includes an insulated union positioned in at least one of the inlet and the outlet of the EGHR heat exchanger.

7. The exhaust system of claim 1, where the second flow control valve includes a pressure actuated flap designed to open when a pressure in the first exhaust conduit exceeds a threshold value.

8. The exhaust system of claim 1, further comprising an insulated joint in the first exhaust conduit upstream of the EGHR heat exchanger inlet and an upstream confluence between the first exhaust conduit and the second exhaust conduit.

9. A method for operating an exhaust system, comprising:
implementing a first operating mode where a first flow control valve positioned in a first exhaust conduit is adjusted to flow exhaust gas through an exhaust gas heat recovery (EGHR) heat exchanger from an inlet extending through a housing of the first exhaust conduit and a second flow control valve positioned in a second exhaust conduit is adjusted to inhibit exhaust gas flow through the second exhaust conduit.

10. The method of claim 9, where the first exhaust conduit is fluidly coupled to the second exhaust conduit in a parallel flow configuration and where the first exhaust conduit includes a body spaced away from a body of the second exhaust conduit.

11. The method of claim 9, further comprising implementing a second operating mode where the first flow control valve positioned in the first exhaust conduit is adjusted to inhibit exhaust gas through the EGHR heat exchanger coupled to the first exhaust conduit and the second flow control valve positioned in the second exhaust conduit is adjusted to inhibit exhaust gas flow through the second exhaust conduit.

12. The method of claim 11, where the second operating mode is implemented responsive to an exhaust gas flow through the first exhaust conduit exceeding a threshold value.

13. The method of claim 11, further comprising implementing a third operating mode where the second flow control valve positioned in the second exhaust conduit is adjusted to permit exhaust gas flow through the second exhaust conduit and inhibit exhaust gas flow through the first exhaust conduit.

14. The method of claim 13, where the third operating mode is transitioned into responsive to an exhaust gas flow through the first exhaust conduit being less than a threshold value.

15. The method of claim 9, where during implementation of the first operating mode, a pressure actuated flap in the second flow control valve is passively opened responsive to a pressure in the first exhaust conduit exceeding a threshold value.

16. The method of claim 9, where the first operating mode is transitioned into responsive to a temperature of the internal combustion engine coolant being below a threshold value.

17. An exhaust system for an internal combustion engine, comprising:
a first exhaust conduit receiving exhaust gas from a cylinder during internal combustion engine operation;
an exhaust gas heat recovery (EGHR) heat exchanger coupled to an exterior surface of the first exhaust conduit and including an inlet and an outlet extending through a housing of the first exhaust conduit;
a second exhaust conduit arranged in a parallel flow arrangement with the first exhaust conduit and including a conduit body spaced away from the first exhaust conduit;
a first flow control valve positioned within the first exhaust conduit and adjusting exhaust gas flow through the EGHR heat exchanger;
a second flow control valve coupled to the second exhaust conduit and adjusting exhaust gas flow through the second exhaust conduit; and
a controller with computer readable instructions stored on non-transitory memory that when executed during an engine-off condition, cause the controller to:
operate the exhaust system in a first mode where exhaust gas flow through the EGHR heat exchanger is permitted and exhaust gas flow through the second exhaust conduit is inhibited by adjusting the first and second flow control valves; and
operate the exhaust system in a second mode where exhaust gas flow through the EGHR heat exchanger is inhibited and exhaust gas flow through the second exhaust conduit is permitted by closing the first flow control valve and opening the second flow control valve.

18. The exhaust system of claim 17, where the controller further includes computer readable instructions stored on the non-transitory memory that when executed cause the controller to:
operate the exhaust system in a third mode where exhaust gas flow through the EGHR heat exchanger is inhibited and exhaust gas flow through the second exhaust conduit is permitted by adjusting the first and second flow control valves.

19. The exhaust system of claim 17, where the second flow control valve includes a flap passively opening when pressure in the first exhaust conduit exceeds a threshold value.

20. The exhaust system of claim 17, further comprising an EGHR insulated union at each of the inlet and the outlet of the EGHR heat exchanger and an exhaust conduit insulated joint in the first exhaust conduit upstream of the EGHR heat exchanger inlet and an upstream confluence between the first exhaust conduit and the second exhaust conduit.
